(19) United States
(12) Patent Application Publication
(10) Pub. No.: US 2020/0148031 A1
(43) Pub. Date: May 14, 2020

(54) VEHICLE BODY EXHAUST DUCT

(71) Applicant: Calsonic Kansei North America, Inc., Farmington Hills, MI (US)

(72) Inventors: Scott Torok, Farmington Hills, MI (US); Silvia Salazar, Farmington Hills, MI (US)

(21) Appl. No.: 16/186,085

(22) Filed: Nov. 9, 2018

(51) Int. Cl. B60H 1/00; B60H 1/32

(52) U.S. Cl. CPC B60H 1/00564; B60H 1/00021; B60H 1/00278; B60H 1/00664; B60H 2001/3255; B60H 2001/00099; B60H 2001/003; B60H 2001/00707; B60H 2001/3241; B60H 1/32

(57) ABSTRACT

A duct assembly is configured to selectively direct conditioned air from a vehicle passenger compartment to a vehicle component. The duct assembly includes a door. The door may be selectively positioned to either direct the conditioned air from the passenger compartment through a duct to the vehicle component or to exhaust the air to another location. In one aspect, the vehicle component includes a battery.

### BACKGROUND

The present disclosure relates generally to systems used to exhaust air from a passenger compartment within a vehicle. More specifically, the present disclosure relates to a duct assembly configured to route air from a passenger compartment within a vehicle toward a vehicle component such as a battery.

Conventional vehicles include a cooling and/or heating system to maintain user comfort during vehicle operation (e.g., an HVAC system). Conditioned air provided by the cooling and/or heating system is directed to the passenger compartment or cabin via one or more ducts, and is eventually vented from the passenger compartment to the surrounding atmosphere. Such venting advantageously may enhance user comfort and prevent over-pressurization of the passenger compartment.

It would be beneficial to use the conditioned air for other purposes instead of venting it to the surrounding atmosphere. These and other advantageous features will be appreciated by those reviewing the present disclosure.

### SUMMARY

At least one embodiment relates to a duct assembly configured to selectively direct conditioned air from a vehicle passenger compartment to a vehicle component. The duct assembly includes a door that may be selectively positioned to either direct the conditioned air from the passenger compartment through a duct to the vehicle component or to exhaust the air to another location.

In some embodiments, the vehicle component includes a battery. In some embodiments, the door includes a flap disposed in the duct proximate a lower edge of the flap. In some embodiments the duct includes a stopper for the door such that in a closed position, the door contacts the stopper to close the duct.

Another embodiment relates to a vehicle including the duct assembly. The vehicle includes a vehicle frame, a vehicle body coupled to the frame, and the vehicle component. The vehicle body defines the vehicle passenger compartment. The vehicle body includes a body panel defining an aperture that is fluidly coupled to the passenger compartment.

In some embodiments, the vehicle includes a control system. The control system may include a mode actuator configured to cause the door positioned in the duct to move between the first position and the second position. The control system may include an air sensor disposed in the duct between the first opening and the door. The air sensor may be communicatively coupled to the mode actuator and configured to measure a flow parameter indicative of a condition of air entering the duct from the passenger compartment. The air sensor may be configured to generate a signal based on the flow parameter. The mode actuator may be configured to move the door from the second position to the first position when the signal from the air sensor indicates the flow parameter exceeds a threshold value.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a perspective view of a duct assembly positioned on a vehicle, according to an illustrative embodiment,

FIG. 2 is a top view of the duct assembly and vehicle of FIG. 1.

FIG. 3 is another perspective view of the duct assembly and vehicle of FIG. 1.

FIG. 4 is another perspective view of the duct assembly and vehicle of FIG. 1.

FIG. 5 is a perspective view of a body panel for a vehicle, according to an illustrative embodiment.

FIG. 6 is another perspective view of the duct assembly and vehicle of FIG. 1.

FIG. 7 is a perspective view of a duct assembly, according to an illustrative embodiment.

FIG. 8 is a perspective view of a first duct portion of the duct assembly of FIG. 7, according to an illustrative embodiment.

FIG. 9 is a perspective view of a second duct portion of the duct assembly of FIG. 7, according to an illustrative embodiment.

FIG. 10 is a perspective view of a flow distribution portion of the duct assembly of FIG. 7, according to an illustrative embodiment.

FIG. 11 is a perspective view of a door of the duct assembly of FIG. 7, according to an illustrative embodiment.

FIG. 12 is a perspective cross-sectional view of an inlet portion of the duct assembly of FIG. 7 with a door configured in a recovery position, according to an illustrative embodiment.

FIG. 13 is a perspective cross-sectional view of an inlet portion of the duct assembly of FIG. 7 with a door configured in a second (“exhaust”) position, according to an illustrative embodiment.

FIG. 14 is a perspective view of a mode actuator separated from the duct assembly of FIG. 7, according to an illustrative embodiment.

FIG. 15 is a perspective view of an air sensor separated from the duct assembly of FIG. 7, according to an illustrative embodiment.

FIG. 16 is a schematic representation of a control system for a duct assembly, according to an illustrative embodiment.

FIG. 17 is a block diagram providing a method of control for the duct assembly of FIG. 7, according to an illustrative embodiment.

FIG. 18 is a perspective view of the duct assembly of FIG. 1, with a door configured in a second (“exhaust”) position, according to an illustrative embodiment.

FIG. 19 is a perspective cross-sectional view through the duct assembly of 8.

FIG. 20 is a perspective view of the duct assembly of FIG. 1, with a door configured in a first (“recovery”) position, according to an illustrative embodiment.

FIG. 21 is a perspective sectional view through the duct assembly of FIG. 20.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

According to an illustrative embodiment, a system is described herein that utilizes conditioned air from a passenger compartment for other purposes such as cooling battery packs that may be present in hybrid-electric or electric vehicles. The system includes ducting that routes the conditioned air to the desired location, and may include a feature such as a door or other mechanism that allows the system to select between venting the air to the surrounding atmosphere or to the battery or other desired location. Recycling the conditioned air and using it for the purpose of cooling vehicle components may reduce the amount of energy required by the vehicle to cool such components and improve fuel economy as a result.

Referring generally to the figures, a duct assembly is configured to vent air from a passenger compartment within a vehicle. The vehicle may include a heating and/or cooling system (e.g., an HVAC system) to improve user comfort during vehicle operation. Conditioned air provided to the passenger compartment by the heating and/or cooling system may be vented into a duct of the duct assembly to prevent over-pressurization of the passenger compartment and/or to regulate a pressure of the passenger compartment. A door disposed in the duct is configured to guide (e.g,, direct, channel, etc.) the circulated air to one of two or more locations. When oriented in a first (“recovery”) position, the door is configured to guide circulated air from the passenger compartment toward a vehicle compartment (e.g., a compartment containing or disposed proximate an electrical component such as a battery, etc.) to control an operating temperature of a vehicle component. Advantageously, regulating the temperature of the vehicle component may contribute to an increase in the performance of the component. Recovering conditioned air, which would otherwise be ejected from the passenger compartment within the vehicle, for heating/cooling of the component also improves the efficiency of the heating and/or cooling system. When oriented in a second (“exhaust”) position, the door is configured such that air from the passenger compartment bypasses the vehicle compartment. For example, the door may be configured to guide air from the passenger compartment to an area outside of the vehicle (e.g., a trunk space fluidly coupled to the surroundings, an underbody of the vehicle, etc.). For example, the system may vent the air from the vehicle during vehicle startup or other conditions, when heating or cooling of the component is not necessary or desired.

The vehicle may include a frame and a vehicle body defining the passenger compartment. The duct assembly may be disposed within a cavity at least partially defined by a body panel of the vehicle body. The body panel may define an aperture that fluidly couples a first opening of the duct to the passenger compartment. The duct assembly may be separated and hidden from the passenger compartment by the body panel. The door may be disposed in the duct below the first opening to maximize the flow area of the duct. The door may be configured as a flap hingedly disposed to the duct proximate a lower edge of the flap. In the second position, the door may block off a second opening of the duct to prevent air from cooling/heating the vehicle component. In the first position, the door may allow air to pass through the second opening to heat or cool the vehicle component. The duct assembly may further include a flow distribution portion, configured to uniformly distribute air along a length of the vehicle component, downstream of the second opening. The flow distribution portion may include a plurality of outlets distributed along a flow direction through the distribution portion. A cross-sectional area of the outlets may increase with increasing distance from the second opening so that a flow rate of air through each of the openings is approximately equal.

The position of the door may be controlled using a control system. The control system may include a mode actuator configured to engage with the door. The mode actuator may be configured to reposition (e.g., rotate, move, etc.) the door based on a flow parameter of the conditioned air entering the duct (e.g., flow rate, temperature, etc.) and/or a temperature of the vehicle component to improve the performance of the vehicle component and/or efficiency of the vehicle's heating/cooling system. These and other advantageous features will become apparent to those reviewing the present disclosure and figures.

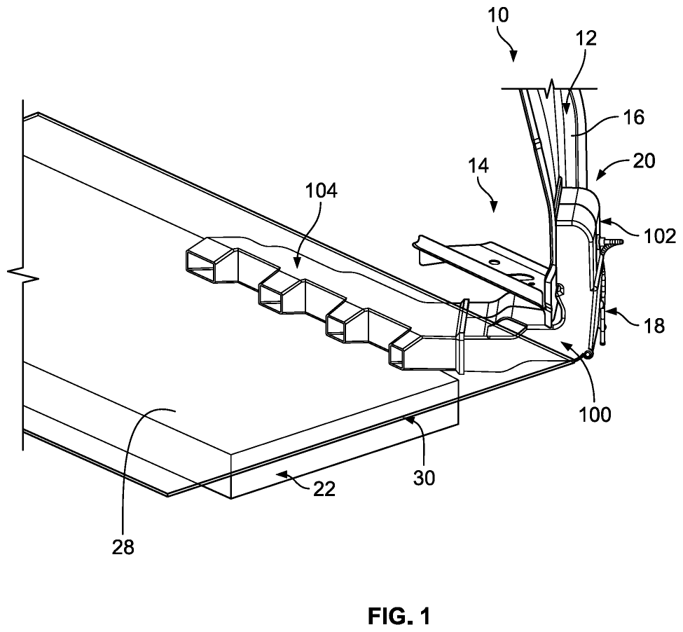

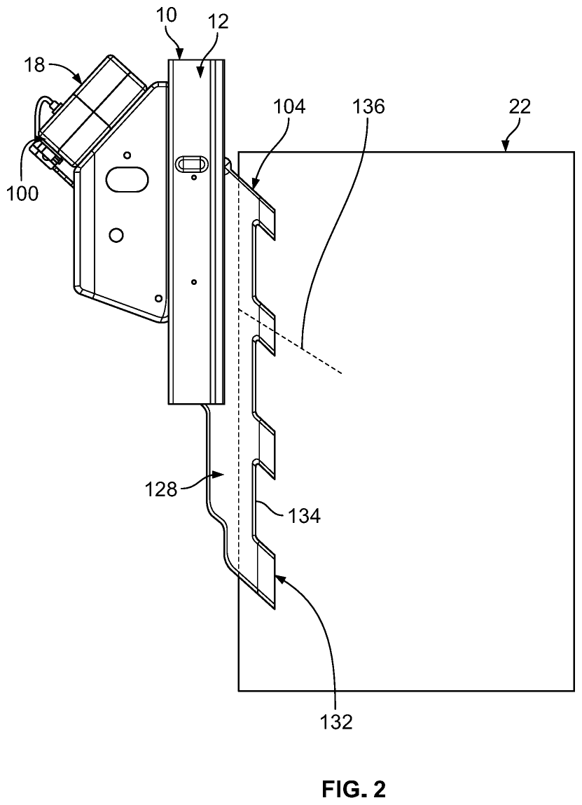

Referring now to FIGS. 1-2, a portion of a vehicle 10 structure is shown according to an illustrative embodiment. The vehicle 10 includes a frame and a vehicle body 12 coupled to the frame. In an embodiment, the vehicle 10 is a passenger vehicle (e.g., a car, a truck, a van, etc.) configured to transport a user. In other embodiments, the vehicle 10 is a commercial transportation or delivery vehicle. In yet other embodiments, the vehicle 10 is a construction vehicle or other off-road utility vehicle. The vehicle body 12 defines a passenger compartment 14 within the vehicle 10 (e.g., a vehicle cab, etc.). The vehicle body 12 includes body panels 16 (e.g., vehicle panels), and other features (e.g., doors, windows, etc., not shown) that are configured to fully enclose the passenger compartment. The vehicle body 12 is configured to protect a user from environmental hazards including weather, road debris, hugs, etc. The vehicle body 12 may include seals to prevent water from entering the vehicle 10 and to reduce road noise for increased user comfort.

The vehicle 10 includes a heating and/or cooling system, referred to hereinafter as an HVAC system, configured to maintain the air in the passenger compartment at a comfortable temperature during vehicle operation. The HVAC system may be configured as an air conditioning system, an engine heat recovery system, etc. The HVAC system may include a series of ducts and fans disposed in the vehicle body 12 and configured to deliver warm and/or cool air (e.g., conditioned air, etc.) to the passenger compartment 14 within the vehicle 10. The vehicle 10 also includes a duct assembly 18 configured to vent air from the passenger compartment 14. As shown in FIG. 1, the duct assembly 18 includes a duct 100 configured for positioning inside of the body panel 16 (e.g., the duct 100 is disposed within a cavity of the vehicle body 12 that is at least partially defined by the body panel 16). The cavity, shown as body cavity 20, is hidden and separated from the passenger compartment 14 by the body panel 16. According to the illustrative embodiment shown in FIG. 1, the body panel 16 may be located behind a rear driver side seat or passenger side seat of the vehicle 10, although according to other illustrative embodiments, it may be provided at another suitable location within the vehicle 10.

The vehicle 10 includes a vehicle component provided therein that may benefit from the receipt of the conditioned air from the HVAC system. In the embodiment of FIGS. 1-2, the vehicle component is a battery 22 configured to power an electric motor and associated equipment (e.g., a battery pack for a hybrid-electric or electric vehicle). In other embodiments, the vehicle component may be a motor, power electronics for an electric vehicle, or another heat generating component. As shown in FIGS. 1-2, the battery 22 is disposed in a battery module underneath the vehicle 10 (e.g., underneath the vehicle body 12, etc.).

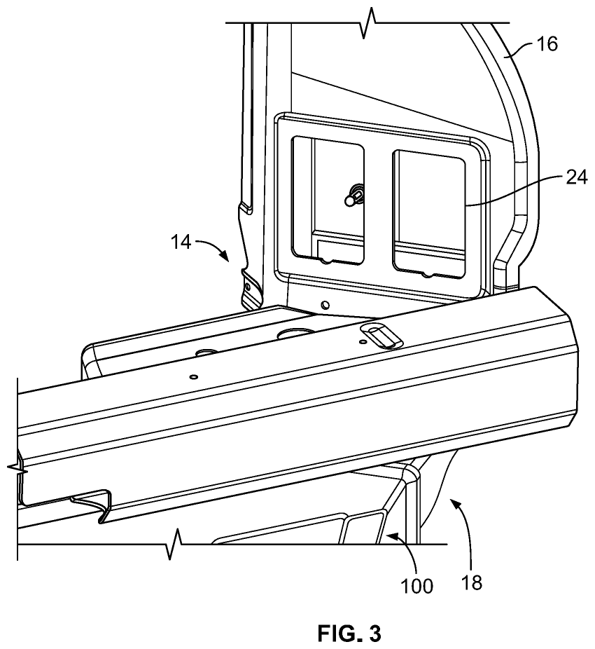

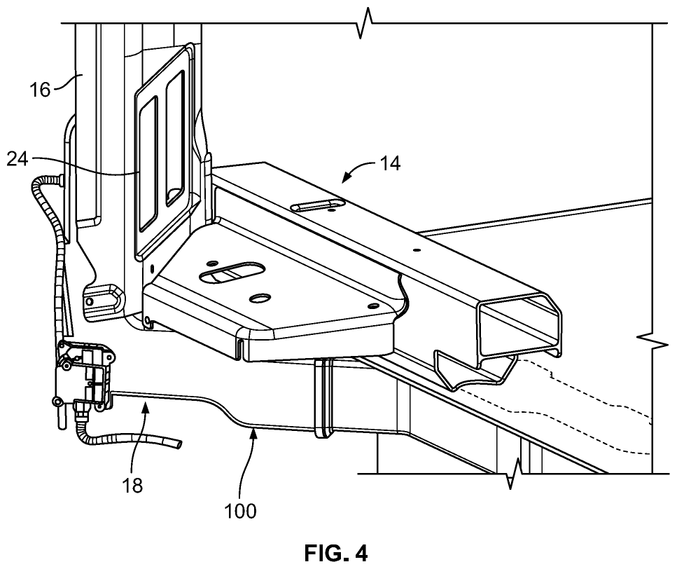

The duct assembly 18 is configured to selectively direct conditioned air that is vented from the passenger compartment 14 to a vehicle compartment proximate the battery 22. As shown in FIGS. 3-4, the duct assembly 18 is configured to receive air from the passenger compartment 14 through one or more apertures 24 defined by the body panel 16. The apertures 24 may be configured in a variety of different shapes and sizes depending on the required flow rate of air from the passenger compartment 14. In larger vehicles, flow rates through the duct assembly 18 may be as high as 300 ft³/min or greater to adequately control the pressure of the passenger compartment 14. Accordingly, ejecting the conditioned air from the vehicle 10 may result in significant energy loss from the HVAC system. It should also be noted and apparent to those reviewing the present disclosure that the air may be routed to the duct assembly in other manners (e.g., not utilizing apertures such as apertures 24 in a body panel 16).

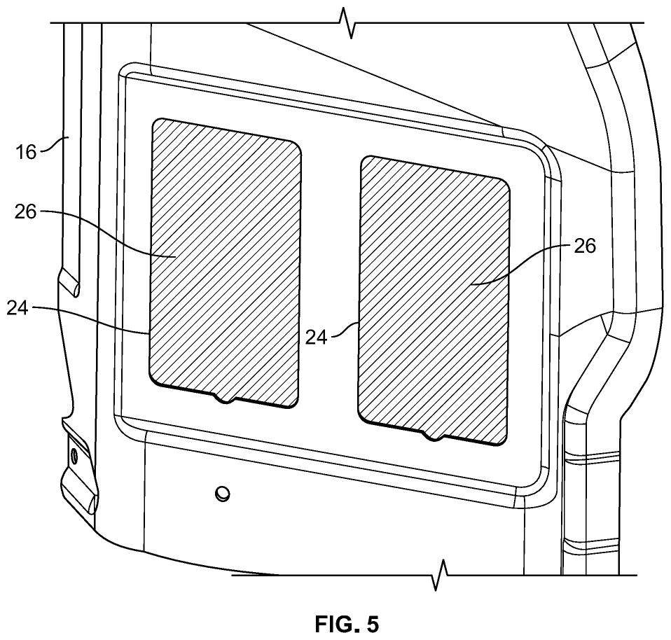

A portion of the body panel 16 proximate the apertures 24 is shown in FIG. 5, according to an illustrative embodiment. The body panel 16 is a single piece of material (e.g., metal) that is stamped or otherwise formed to include two horizontally aligned apertures 24. Each of the apertures 24 is fluidly coupled to the passenger compartment 14 (see also FIGS. 3-4). The apertures 24 may be configured in a variety of shapes and sizes. In the embodiment of FIG. 5, each of the apertures 24 is substantially rectangular. A cross-sectional area of each of the apertures 24 is approximately 30 in². In some embodiments, the vehicle 10 further includes a vent member 26 coupled to one of the body panel 16 and a duct 100 of the duct assembly 18. The vent member 26 may be configured to control the flow of air passing through the apertures 24 to regulate a pressure of the passenger compartment 14. The vent member 26 may be reconfigurable between a closed position in which the vent member 26 prevents air in the passenger compartment 14 from passing through the apertures 24, and an open position in which the vent member 26 allows at least some air to pass through the apertures 24. In an illustrative embodiment, the vent member 26 may be configured as a check-valve configured to allow one-way flow through the apertures 24 (e.g., a door configured to seal against the body panel 16 on a duct side of the body panel 16). The check-valve may be sized to cover both apertures 24 simultaneously. Alternatively, the vent member 26 may include an individual check-valve for each aperture 24. The check-valve may be self-regulated (e.g., spring loaded, etc.) or automatically regulated by a control module to maintain a comfortable pressure within the passenger compartment 14.

By way of example, the vent member 26 may include a spring that applies a force to the vent member 26 (e.g., toward the body panel 16) in proportion to an amount of deflection of the spring. As the amount of pressure in the passenger compartment 14 increases (e.g., due to activation of a HVAC system that pulls air into the passenger compartment 14 from the surroundings, etc.), the vent member 26 rotates away from the aperture 24 toward the open position. The spring deflects in response to the rotation of the vent member 26. The spring limits the amount of air vented from the passenger compartment 14. As the amount of air entering the passenger compartment 14 through the HVAC system decreases (e.g., due to operating the HVAC system in an air recirculation mode, etc.) the spring causes the vent member 26 to move toward the closed position, and thereby provide a more uniform pressure within the passenger compartment 14.

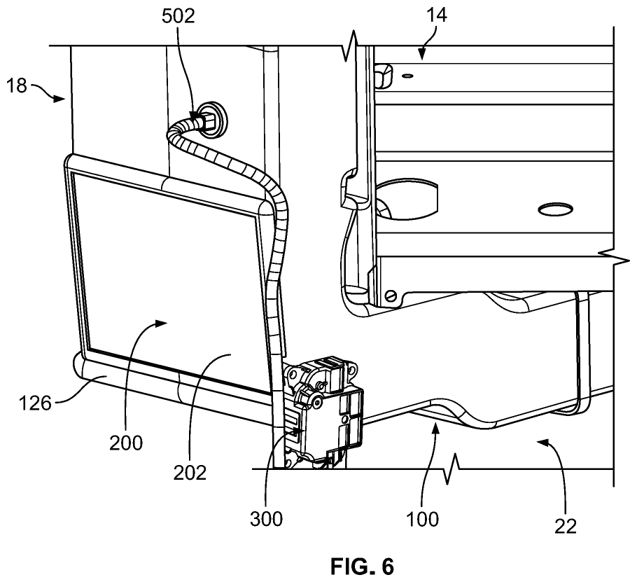

Referring now to FIG. 1, the duct assembly 18 is configured to control the flow of air from the passenger compartment 14 to the vehicle compartment proximate the battery 22. In other illustrative embodiments, the duct assembly 18 is configured to control the flow of air from the passenger compartment 14 directly to the battery 22 and/or components that are thermally coupled to the battery 22. As shown in FIG. 6, the duct assembly 18 includes a door 200 and a control system 300 configured to reposition the door 200. In determining that the door 200 should be repositioned, the control system 300 may rely on inputs such as (but not necessarily limited to) a flow parameter indicative of a condition of air received by the duct assembly 18 from the passenger compartment 14, the temperature of the battery 22, an operating condition of the battery 22, the temperature outside the vehicle or adjacent to the vehicle component, and/or an operating condition of the vehicle or the HVAC system (e.g., the door may be opened any time the vehicle or the HVAC system is operating).

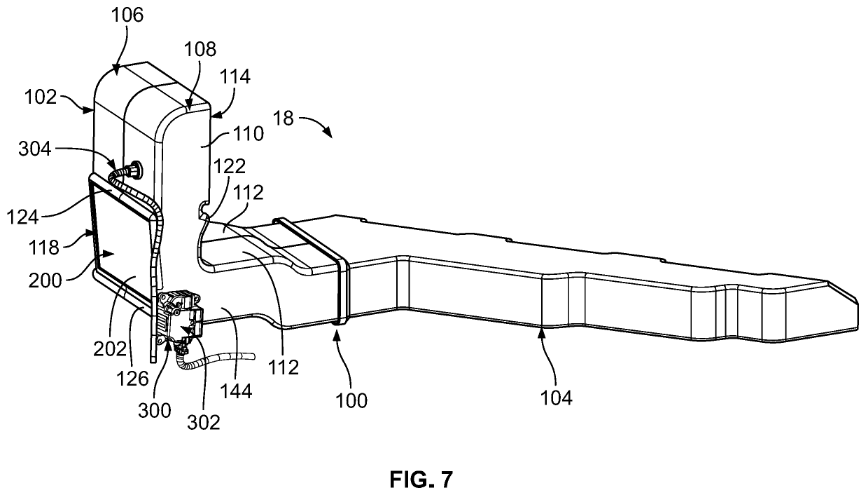

The duct assembly 18 is shown separated from the vehicle 10 in FIG. 7, according to an illustrative embodiment. The duct assembly 18 includes a duct 100 and a door 200 disposed within a cavity defined by the duct 100. The duct assembly 18 also includes a control system 300 configured to control the position of the door 200 relative to the duct 100. As shown in FIG. 7, the duct 100 includes two portions—an inlet portion 102 configured to receive air from the passenger compartment 14 in the vehicle 10 (see also FIG. 1), and a distribution portion 104 fluidly coupled to the inlet portion 102.

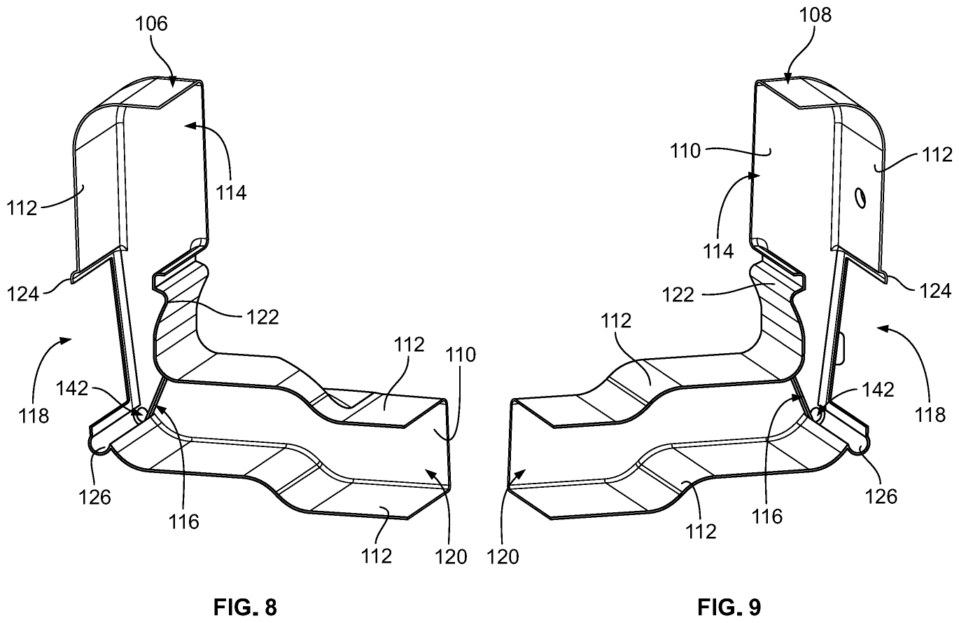

As shown in FIGS. 7-9, the inlet portion 102 of the duct 100 is subdivided into two portions (e.g., halves). It should be understood that the duct 100 may be formed as a single portion or more than two portions in other illustrative embodiments. A first portion 106 of the inlet portion 102 is shown in FIG. 8, while a second portion 108 of the inlet portion 102 is shown in FIG. 9. As shown in FIGS. 8-9, the first and second portions 106, 108 of the inlet portion 102 are similar to one another, with the second portion 108 being approximately a mirror image of the first portion 106 (although it should be understood that the two portions may differ from each other according to other embodiments). Each portion 106, 108 may be formed from a single piece of material or multiple pieces of material welded or otherwise secured together. In an embodiment, each portion 106, 108 is made from a single piece of plastic (e.g., nylon, polycarbonate, etc.) by an injection molding operation. In another embodiment, each portion 106, 108 is made from one or more pieces of metal (e.g., aluminum, steel, etc.) by a stamping and/or bending operation.

As shown in FIGS. 8-9, each portion 106, 108 of the inlet portion 102 includes a base wall 110 and a plurality of side walls 112 extending from the base wall 110 in a direction that is substantially perpendicular to the base wall 110. Together, the base wall 110 and the plurality of side walls 112 form a channel (e.g., a U-channel) configured in an L-shape. As shown in FIG. 7, the inlet portion 102 of the duct 100 is formed by securing together the side walls 112 from each of the two halves 106, 108 (e.g., by welding or another suitable fastening mechanism).

As shown in FIGS. 8-9, the inlet portion 102 of the duct 100 includes at least three openings, a first opening configured to receive air from the passenger compartment 14, a second opening configured to provide air from the passenger compartment 14 to a battery 22 or other vehicle component to control a temperature of the vehicle component, and a third opening configured to vent air from the passenger compartment 14 to the surroundings (e.g., to another location away from the vehicle component, etc.). Each opening is defined by a gap between adjacent side walls 112. A first opening 114 is disposed proximate an upper end of the inlet portion 102. A second opening 116 and a third opening 118 are disposed proximate a lower end of the inlet portion 102, proximate a curved section of the inlet portion 102. Each of the second opening 116 and the third opening 118 are at least partially defined along their perimeter by a side wall 112 whose height is less than a height of the remaining side walls 112 (e.g., such that the side walls 112 at the perimeter of the openings 116, 118 do not extend as far from the base wall 110 as the side walls 112 between openings). A fourth opening 120 of the duct 100 is disposed proximate an end of the inlet portion 102 opposite the second opening 116. The openings 114, 116, 118, 120 may be formed in a variety of different shapes (e.g., circular, rectangular, etc.). In the embodiment of FIGS. 8-9, each opening is substantially rectangular, although the size and shape of such openings may differ in other embodiments.

As shown in FIGS. 8-9, the inlet portion 102 of the duct 100 includes a plurality of recessed portions, each recessed portion formed into a side wall 112 (e.g., formed by a substantially arcuate section of the side wall 112). Each of the recessed portions is disposed proximate an upper or lower end of one, or both, of the second opening 116 and the third opening 118. A first recessed portion 122 is disposed proximate an upper end of the second opening 116, a second recessed portion 124 is disposed proximate an upper end of the third opening 118, and a third recessed portion 126 is disposed proximate a lower end of each of the second and third openings 116, 118. As will be further described, each of the recessed portions 122, 124, 126 is configured to receive a portion of the door 200 (see also FIG. 7).

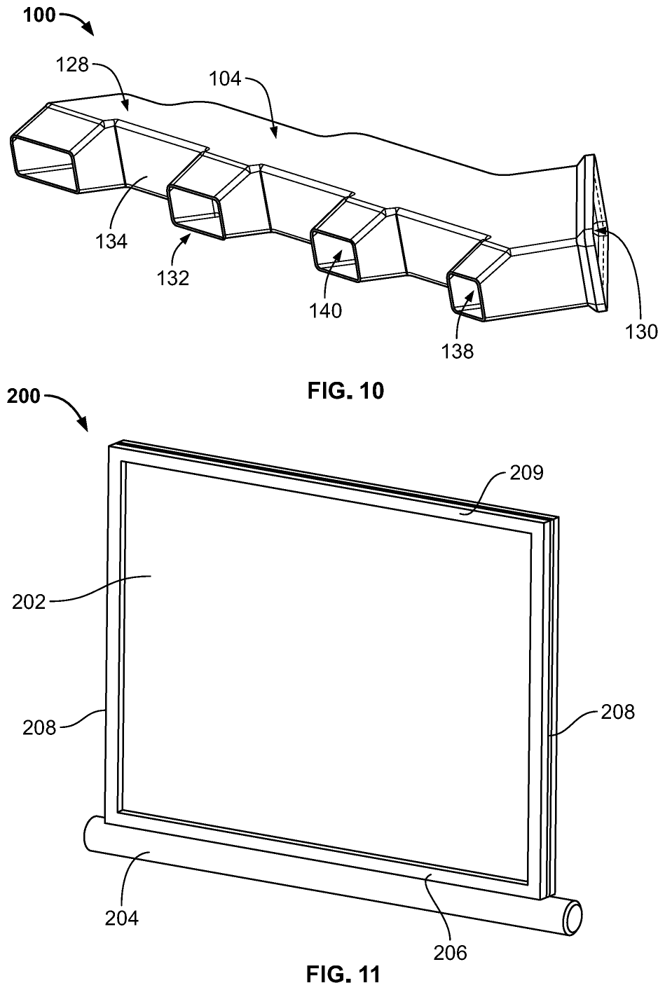

FIG. 10 shows the distribution portion 104 of the duct 100 separated from the remainder of the duct assembly 18 (see also FIG. 7). The distribution portion 104 is configured to direct air from the inlet portion 102 along a length of the vehicle compartment (acting, for example, as a manifold for such air distribution). As shown in FIG. 1, the distribution portion 104 is configured to direct air along a length of a battery module 30 and across and upper surface 28 of the battery 22. As shown in FIG. 7, the distribution portion 104 is coupled to the inlet portion 102 such that air leaving through the second opening 116 is substantially received by the distribution portion 104. In an embodiment, the distribution portion 104 is removably coupled to the inlet portion 102 using a fastener (e.g., bolts, screws, clips, tabs, or a combination thereof) or another suitable coupling mechanism. A seal may be included along an interface between the inlet portion 102 and the distribution portion 104 to prevent air from bypassing the distribution portion 104. In other embodiments, the distribution portion 104 may be fixedly coupled to the inlet portion 102 by welding or by using a suitable adhesive product.

As shown in FIG. 10, the distribution portion 104 includes an outer wall 128 defining a cavity 130 and a plurality of outlets 132 disposed on a side surface 134 of the outer wall 128. Each one of the plurality of outlets 132 is configured as a rectangular passage that extends substantially away from (e.g., outwardly from) the side surface 134. As shown in FIG. 2, a central axis 136 of each of the plurality of outlets 132 extends away from the side surface 134 at an angle relative to the side surface 134 (i.e., at an angle relative to a flow direction through the cavity 130, at an angle relative to a plane that is substantially coplanar with the side surface 134, etc.). In an alternative embodiment, each of the plurality of outlets 132 may extend away from the side surface 134 in a direction that is substantially normal to the side surface 134. In yet other embodiments, the plurality of outlets 132 may be configured as apertures through the outer wall 128. As shown in FIG. 10, the plurality of outlets 132 are spaced approximately evenly along the side surface 134, at increments of approximately equal size, parallel to a flow direction through the cavity 130. In the embodiment of FIG. 10, the distribution portion 104 includes four outlets.

The shape, size, number, and arrangement of the plurality of outlets 132 may be different depending on the cooling requirements for the battery 22 and the geometry of the battery 22. As shown in FIGS. 1-2, the distribution portion 104 is configured to provide air received from the passenger compartment 14 along a length of the battery module 30 and across an upper surface 28 of the battery 22. As shown in FIG. 10, the size of the outlets 132 varies with distance along the duct 100. In the embodiment of FIG. 10, a cross-sectional area of each of the plurality of outlets 132 increases along a flow direction through the distribution portion 104 (i.e., increases with increasing distance from the second opening 116 as shown in FIGS. 8-9). The cross-sectional area of a first outlet 138, which is disposed proximate the second opening 116 of the inlet portion 102, is less than a cross-sectional area of a second outlet 140, which is disposed farther from the second opening 116 than the first outlet 138. This advantageously allows for more uniform distribution of the conditioned air to the battery.

In the embodiment of FIG. 10, a height of each of the plurality of outlets 132 is approximately equal in the flow direction, while a length of each of the plurality of outlets 132, in a direction substantially parallel to the flow direction, increases in the flow direction (i.e., increases with increasing distance from the second opening 116). Among other benefits, maintaining a constant height between outlets reduces the vertical clearance required between the battery 22 and the vehicle body 12 in the battery module 30 (see also FIG. 1). Maintaining a constant outlet height also fixes a height of the distribution portion 104 (i.e., the distance between the upper and lower surfaces of the distribution portion 104 normal to the flow direction).

Referring again to FIG. 7, the door 200 may be selectively positioned to either direct the air from the passenger compartment 14 through the duct 100 to the battery 22 (or other vehicle component), or to exhaust the air to another location. As shown in FIG. 7, the door 200 is sized to completely block off each of the second opening 116 and the third opening 118, so as to prevent air from passing through one of the second opening 116 and the third opening 118. FIG. 11 shows the door 200 separated from the rest of the duct assembly 18, according to an illustrative embodiment. The door 200 includes a flap 202 that is hingedly disposed to the duct 100 proximate a lower edge 206 of the flap 202 and a support member 204 affixed to a lower edge 206 of the flap 202. The flap 202 and the support member 204 may be formed from a single piece of material or from separate pieces of material that are welded, glued, or otherwise fastened together. The support member 204 is configured to couple the door 200 to an actuator mechanism, which is disposed on an external surface of the duct 100. In the embodiment of FIG. 11, the support member 204 is configured as a cylindrical shaft (e.g., post, etc.) that extends along the lower edge 206 of the flap 202 and protrudes beyond the flap 202 (e.g., such that either end of the support member 204 extends a distance beyond a side edge 208 of the flap 202).

Returning to FIGS. 6-7, the flap 202 is hingedly mounted below the first opening 114. Among other benefits, separating the door 200 from the first opening 114 provides space for an air sensor 304, which can be configured to measure a flow parameter indicative of a condition of air entering the duct 100 from the passenger compartment 14. The support member 204 is received within and rotatably coupled to the third recessed portion 126 of the duct 100. Each end of the support member 204 is configured to be received within an opening, shown as retaining opening 142, through the base wall 110 of the duct 100 (see also FIGS. 8-9), such that each end of the support member 204 is accessible from outside of the duct 100.

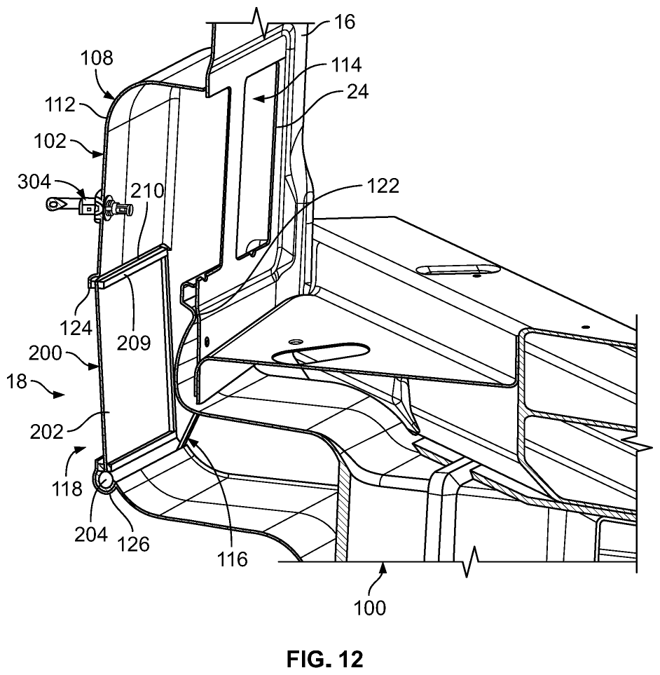

FIG. 12 shows a cross-section through the inlet portion 102 of the duct assembly 18, according to an illustrative embodiment. The flap 202 of the door 200 is sized to completely block off each of the second opening 116 and the third opening 118. The flap 202 may be formed in a variety of different shapes. As shown in FIGS. 11-13, the flap 202 is substantially rectangular and matches the shape of the second and third openings 116, 118. A height of flap 202 in a direction substantially normal to the support member 204 is greater than a height of each of the first and second openings 116, 118. Similarly, a width of the flap 202 in a direction substantially parallel to the support member 204 is slightly larger than a width of each of the second and third openings 116, 118. The door 200 includes seals 209 disposed along a perimeter on either side of the flap 202 to prevent air from bypassing through an interface between the door 200 and the inlet portion 102 of the duct 100.

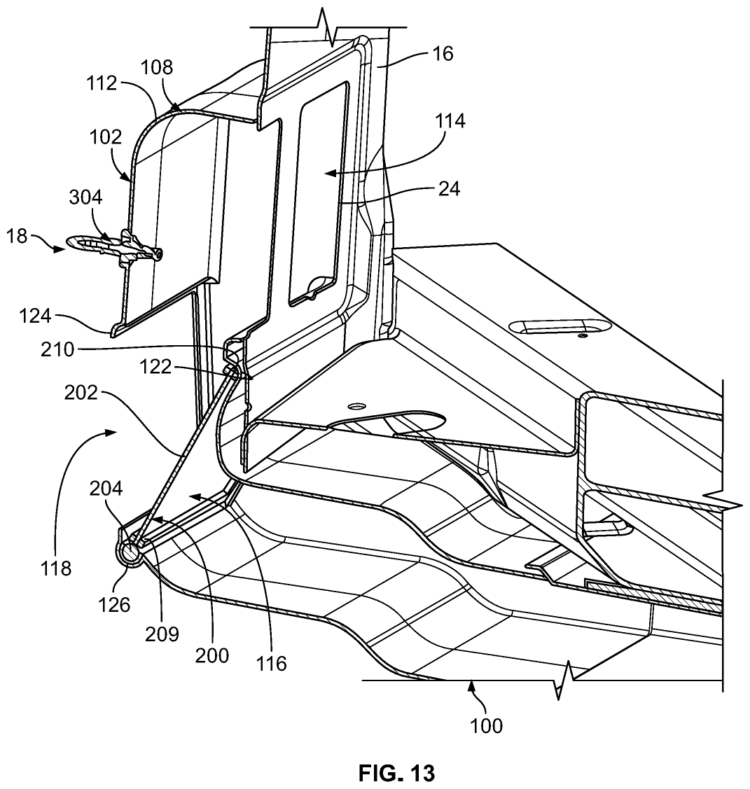

The door 200 is movable between a first (“recovery”) position in Which the air entering the duct 100 through the first opening 114 is guided toward the second opening 116 in isolation of the third opening 118, and a second (“exhaust”) position in which the air entering the duct 100 through the first opening 114 is guided toward the third opening 118 in isolation of the second opening 116. FIGS. 12 and 13 show the door 200 in the first position and the second position, respectively. As shown in FIGS. 12-13, an upper edge 210 of the flap 202 is configured to be received within one of the first recessed portion 122 and the second recessed portion 124, depending on the position of the door 200.

In the embodiment of FIG. 12, the recessed portions 122, 124 are configured as stoppers for the door 200. The stoppers (e.g., recessed portions 122, 124) are configured such that in a closed position (e.g., first or second position), the door 200 contacts the stopper to close the duct 100. The upper edge 210 of the flap 202 is configured to press against the first recessed portion 122 and the second recessed portion 124 in the first and second positions, respectively. As shown in FIG, 12, in the first position, the flap 202 of the door 200 is positioned to block off the third opening 118. The upper edge 210 of the flap 202 is received within the second recessed portion 124 which, advantageously, reduces the aerodynamic drag that might otherwise restrict the flow of air through the duct 100. Air flowing through the duct 100 creates a pressure which acts to push (e.g., force, retain, etc.) the door 200 against the side walls 112 surrounding the third opening 118, and thereby improve sealing at an interface between the door 200 and the duct 100.

As shown in FIG. 13, in the second position, the flap 202 is positioned to block off the second opening 116. The upper edge 210 of the flap 202 is received within the first recessed portion 122, which functions similarly to the second recessed portion 124 to help improve sealing and reduce flow restriction through the duct 100.

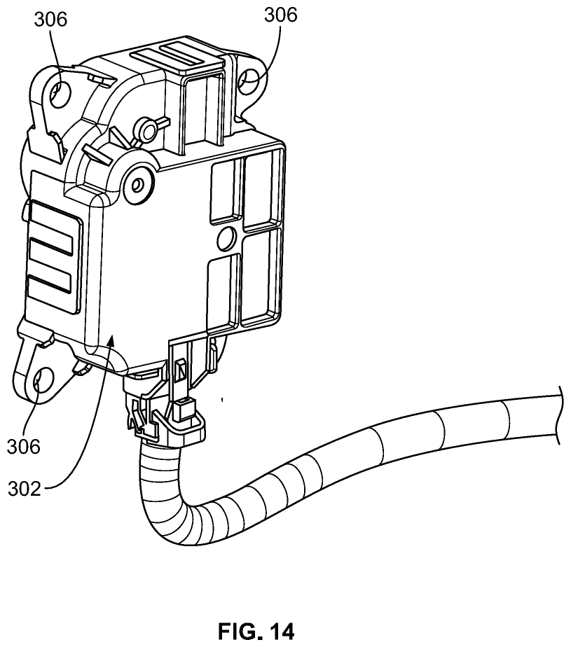

Referring again to FIG. 7, a control system 300 for the duct assembly 18 includes a mode actuator 302 and an air sensor 304 communicatively coupled thereto. The mode actuator 302 is configured to cause the door 200 to move between the first position and the second position. As shown in FIG. 7, the mode actuator 302 is disposed on an exterior surface 144 of the inlet portion 102 of the duct 100. The mode actuator 302 is shown separated from the duct assembly 18 in FIG. 14, according to an illustrative embodiment. As shown in FIG. 14, the mode actuator 302 includes a plurality of mounting points 306, each disposed proximate a perimeter of the mode actuator 302. The mounting points 306 are configured to removably couple the mode actuator 302 to the duct 100. Specifically, the mounting points 306 are configured to receive one, or a combination of, bolts, screws, clips, tabs, or another mechanical fastener to secure the mode actuator 302 to the duct 100.

The mode actuator 302 is configured to receive an end of the support member 204 (see also FIG. 13), which extends through the base wall 110 of the second portion 108 of the inlet portion 102. The mode actuator 302 is configured to apply a rotational torque to the support member 204 to move the flap 202, and thereby control the flow of air through the duct 100. In an illustrative embodiment, the mode actuator 302 is a two position rotary actuator configured to reposition the door 200 in either the first position or the second position. In other embodiments, the mode actuator 302 may he configured to hold the door in-between the first and second positions in order to allow an amount of air through both the second and third openings 116, 118 (i.e., to allow a first fraction of the air received from the passenger compartment 14 to pass through the second opening 116 and a second fraction of air to pass through the third opening 118).

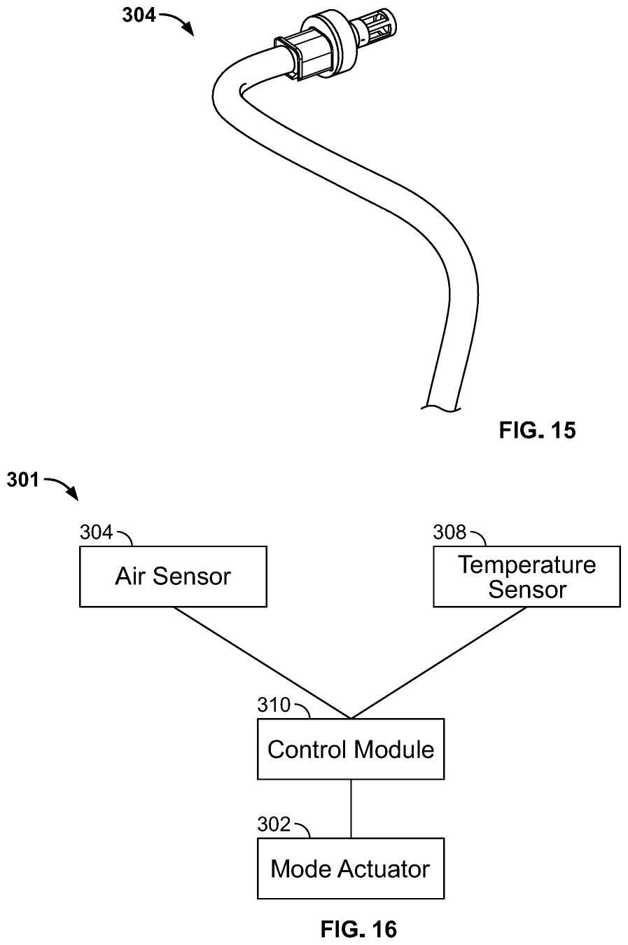

As shown in FIGS. 7 and 15, the control system 300 additionally includes an air sensor 304 that is communicatively coupled to the mode actuator 302. The air sensor 304 may be disposed at a variety of positions within the duct 100. As shown in FIGS. 12-13, the air sensor 304 is disposed in the duct 100 between the first opening 114 and the door 200 (i.e., between the aperture 24 in the body panel 16 and the door 200). In the embodiment of FIGS. 12-13, the air sensor 304 is removably coupled to the second portion 108 of the inlet portion 102. Specifically, the air sensor 304 is coupled to a side wall 112 of the second portion 108. The air sensor 304 extends from the side wall 112 toward a central axis of the duct such that the air sensor 304 is at least partially suspended within the duct 100.

The mode actuator 302 is configured to reposition the door 200 based on an output from the air sensor 304. The air sensor 304 is configured to measure a flow parameter indicative of a condition of the air entering the duct 100 from the passenger compartment 14 and to generate a signal based on the flow parameter. In the embodiment of FIGS. 12-13, the air sensor 304 is a temperature sensor configured to measure a temperature of conditioned air entering the duct 100. The door 200 is configured to be actuated based on at least one of a signal from the air sensor 304 or a condition of the battery 22 or other vehicle component.

In the embodiment of FIGS. 12-13, the mode actuator 302 is configured to receive the signal from the air sensor 304. The mode actuator 302 is configured to move the door 200 relative to the duct 100, between the first position and the second position, when the signal from the air sensor 304 indicates the flow parameter is within a predetermined range and/or exceeds a threshold value. The flow parameter may be one of a variety of different flow parameters including flow rate, temperature, pressure, etc.

In the embodiment of FIG. 7, the air sensor 304 is electrically connected to the mode actuator 302. In other embodiments, as shown in the block diagram of a control system 301 in FIG. 16, the air sensor 304 is communicatively coupled to the mode actuator 302 via a control module 310. The control module 310 is configured to generate a control signal based on the signal received from the air sensor 304. The mode actuator 302 is configured to move the door 200 based on the control signal received from the control module 310. In an embodiment, the mode actuator 302 is an electromechanical actuator. In yet other embodiments, the mode actuator 302 is a temperature-based valve such as a bi-metal spring configured to move the door 200 based on the temperature of the spring. The valve is positioned within the duct 100 such that the valve is exposed to air entering the duct from the passenger compartment 14. Among other benefits, using a temperature-based valve eliminates the need for a separate air sensor 304.

As shown in FIG. 16, the control system 300 additionally includes a temperature sensor 308 configured to measure a temperature of the battery 22 for the vehicle 10 (see FIG. 1) and output a signal, referred to hereinafter as a temperature signal, indicative of the temperature of the battery 22. The control module 310 may be configured to receive the temperature signal and generate a control signal based on both the temperature signal and the signal from the air sensor 304.

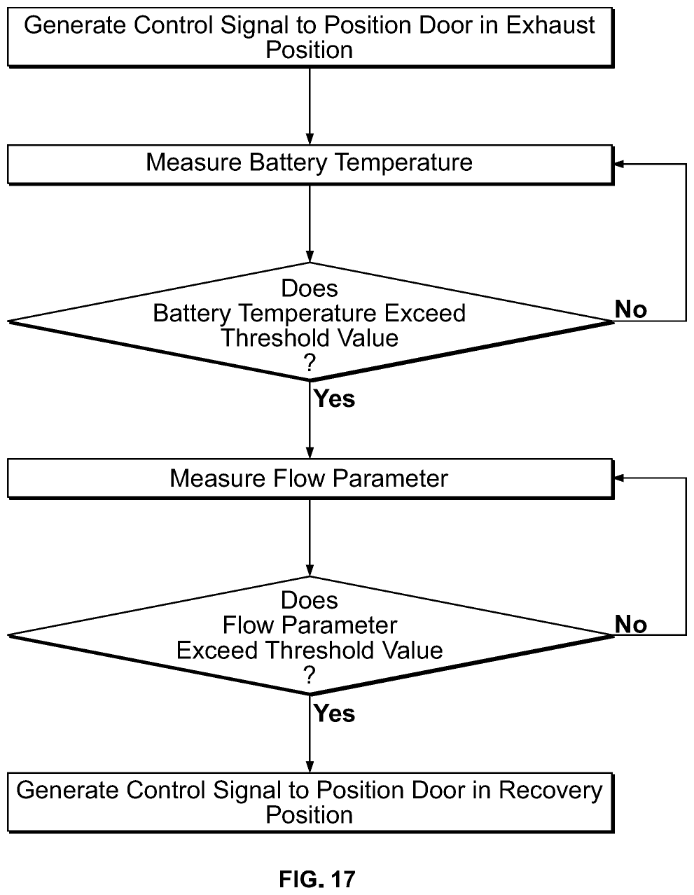

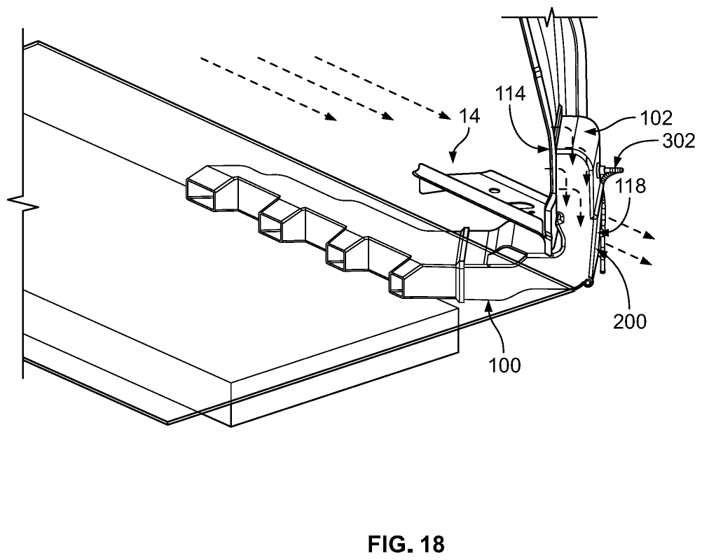

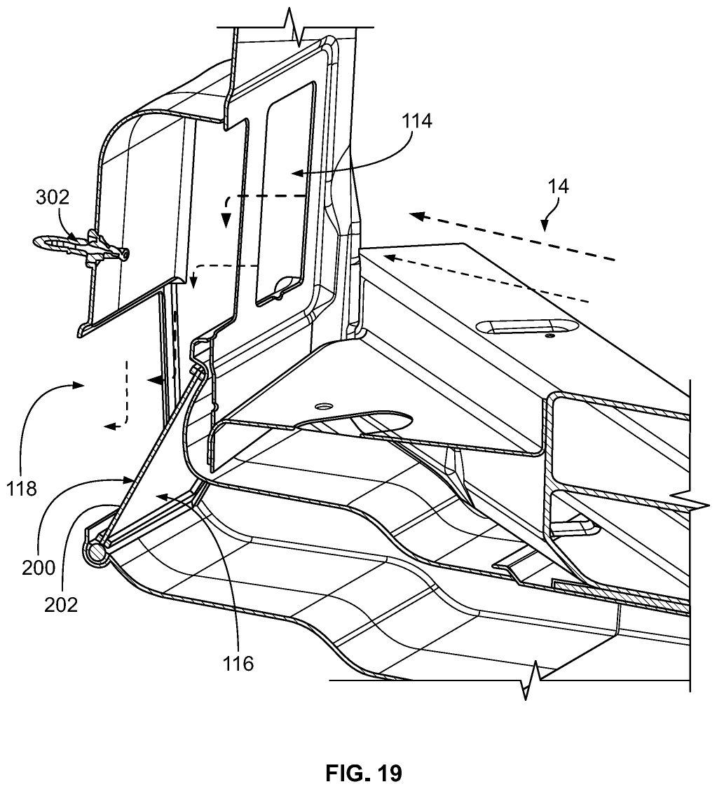

A method of controlling the door 200 is shown in FIG. 17, according to an illustrative embodiment. The method includes positioning the door 200 in the second position, for example, by generating a control signal that causes the mode actuator 302 to rotate the flap 202 of the door 200 toward the second opening 116. The flow configuration in the second position is shown in FIGS. 18-19. Air is received through the first opening 114 of the duct 100 from the passenger compartment 14. Air is directed from the first opening 114 in a substantially vertical direction (e.g., top to bottom as shown in FIGS. 18-19, downwardly, etc.) through the inlet portion 102 of the duct 100 and ejected from the duct 100 through the third opening 118. In some embodiments, the air is ejected from the third opening 118 into the vehicle's 10 surroundings. In other embodiments, air is ejected from the third opening 118 into a trunk space or other area of the vehicle 10 before being ejected to the surroundings.

Referring back to FIG. 17, the method additionally includes measuring a temperature of the battery 22 or other vehicle component using the temperature sensor 308 to determine whether the temperature of the battery 22 or other vehicle component exceeds a threshold value (e.g., whether a temperature of the battery 22 is greater than an upper threshold value or less than a lower threshold value). The method additionally includes measuring a flow parameter indicative of a condition of air entering the duct 100 to determine whether the flow parameter is within a predetermined range, or alternatively, if the flow parameter exceeds a threshold value. The method includes generating a control signal to reposition the door 200 based on both the measured temperature of the battery 22 and the flow parameter of air entering the duct 100 from the passenger compartment 14.

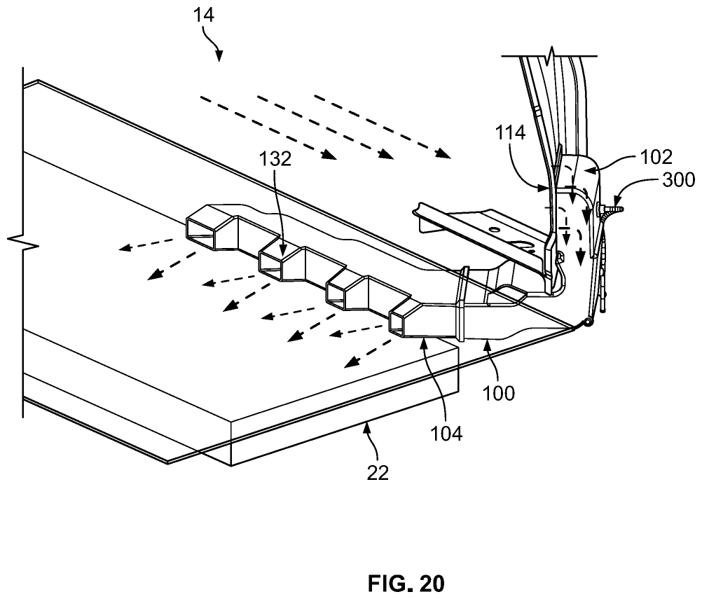

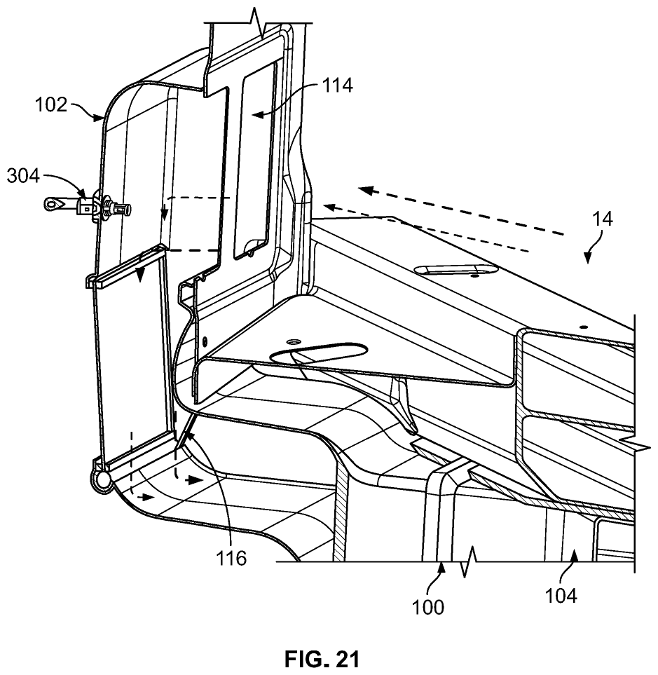

In an illustrative embodiment, the flow parameter is a temperature of the air entering the duct 100 from the passenger compartment 14. The control module is configured to generate a control signal causing the door 200 to move from the second position to the first position when the temperature of the air is less than the measured temperature of the battery 22. The flow configuration is shown in the first position in FIGS. 20-21. Air is received through the first opening 114 of the duct 100 from the passenger compartment 14. Air is directed in a substantially vertical direction through the inlet portion 102 of the duct 100 and passes from the inlet portion 102 of the duct 100 to the distribution portion 104 through the second opening 116. Air is ejected from the plurality of outlets 132 into the battery module to cool the battery 22. In other embodiments, the control system 300 is configured to reposition the door 200 to heat the battery 22, or to heat/cool another vehicle component or compartment.

The control logic shown in FIG. 17 is provided for illustrative purposes only. Many variations of the control logic may be implemented without departing from the inventive principles disclosed herein. For example, in some embodiments the control system 300 may be configured to generate a control signal based on a signal from the air sensor 304 alone. In other embodiments, the control system 300 may be configured to move the door 200 to a position inbetween the first and second positions depending on one, or a combination of, the temperature of the battery 22 and the flow parameter of air entering the duct 100. In yet other embodiments, the control system 300 may monitor a position of the vent member 26 and reposition the door 200 based at least partially on the position of the vent member 26.

The duct assembly 18, of which various illustrative embodiments are disclosed herein, provides several advantages over conventional vehicle venting systems. The duct assembly 18 allows for the recovery of conditioned air to help control a temperature of a vehicle component, rather than venting the air from the vehicle 10 (e.g., to the surroundings, to a different part of the vehicle 10 away from the vehicle component, etc.). The duct assembly 18 includes a door 200 and a control system 300, 301 to guide the flow of conditioned air to different locations. By application of the inventive principles herein, the duct assembly 18 could be used to control the temperature of multiple vehicle components depending on their operating condition and/or a condition of the air leaving the passenger compartment 14, thereby improving the performance of the components and the overall efficiency of the vehicle's 10 HVAC system.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other illustrative embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various illustrative embodiments without departing from the scope of the present invention.

What is claimed is:

1. A duct assembly configured to selectively direct conditioned air from a vehicle passenger compartment to a vehicle component, the duct assembly comprising a door that may be selectively positioned to either direct the conditioned air from the passenger compartment through a duct to the vehicle component or to exhaust the air to another location.

2. The duct assembly of claim 1, wherein the vehicle component comprises a battery.

3. The duct assembly of claim 1, wherein the door comprises a flap that is hingedly disposed to the duct proximate a lower edge of the flap.

4. The duct assembly of claim 1, wherein the duct includes a stopper for the door such that in a closed position, the door contacts the stopper to close the duct.

5. The duct assembly of claim 1, further comprising a temperature sensor in the duct, and wherein the door is configured to be actuated based on at least one of a signal from the temperature sensor or a condition of the vehicle component.

6. The duct assembly of claim 1, wherein the duct includes a plurality of outlets adjacent the vehicle component, and wherein the sizes of the outlets varies with distance along the duct.

7. The duct assembly of claim 1, wherein the duct is configured for positioning inside of a body panel.

8. The duct assembly of claim 1, wherein the duct includes a first opening configured to receive air from the vehicle passenger compartment and a second opening configured to provide air from the passenger compartment to the vehicle component to control a temperature of the vehicle component.

9. The duct assembly of claim 8, wherein the duct further includes a third opening, and wherein the door is movable between a first position in which the air entering the duct through the first opening is guided toward the second opening in isolation from the third opening, and an second position in which air entering the duct through the first opening is guided toward the third opening in isolation from the second opening.

10. A duct assembly comprising:
a duct comprising:
a first opening configured to receive air from a vehicle passenger compartment;
a second opening configured to provide air to a vehicle component to control a temperature of the vehicle component; and
a third opening; and
a door disposed in the duct, wherein the door is movable between a first position in which the air entering the duct through the first opening is guided toward the second opening in isolation from the third opening, and a second position in which air entering the duct through the first opening is guided toward the third opening in isolation from the second opening.

11. The duct assembly of claim 10, wherein the door further comprises a flap disposed in the duct below the first opening, wherein the flap is hingedly disposed to the duct proximate a lower edge of the flap.

12. The duct assembly of claim 11, wherein the duct further comprises a recessed portion, wherein the flap is configured to press against the recessed portion when the door is in one of the first position or the second position.

13. The duct assembly of claim 1, further comprising a control system that comprises:
an air sensor disposed in the duct between a first opening of the duct and the door; and
a mode actuator, wherein the mode actuator is configured to reposition the door based on an output from the air sensor.

14. The duct assembly of claim 10, further comprising a flow distribution portion comprising a plurality of outlets configured to provide air to the vehicle component, wherein a first outlet of the plurality of outlets is located closer to the second opening than a second outlet of the plurality of outlets, and wherein the first outlet is smaller than the second outlet.

15. The duct assembly of claim 10, wherein the duct is configured to be at least partially disposed within a cavity formed by one or more body panels of a vehicle.

16. A vehicle comprising the duct assembly as recited in claim 10, the vehicle further comprising:
a frame;
a vehicle body coupled to the frame, the vehicle body defining the vehicle passenger compartment, the vehicle body also comprising a body panel defining an aperture that is fluidly coupled to the passenger compartment; and
the vehicle component.

17. The vehicle of claim 16, wherein the vehicle component comprises a battery.

18. The vehicle of claim 16, wherein the duct assembly is configured to be at least partially disposed within a cavity formed by one or more body panels.

19. The vehicle of claim 16, further comprising a control system comprising:
a mode actuator configured to cause the door to move between the first position and the second position; and
an air sensor communicatively coupled to the mode actuator, the air sensor disposed in the duct between the first opening and the door, the air sensor configured to measure a flow parameter indicative of a condition of air entering the duct from the passenger compartment, the air sensor configured to generate a signal based on the flow parameter;
wherein the mode actuator is configured to move the door from the second position to the first position when the signal from the air sensor indicates the flow parameter exceeds a threshold value.

20. The vehicle of claim 19, further comprising a temperature sensor configured to measure the temperature of the vehicle component and generate a temperature signal, the control system configured to receive the temperature signal, the control system configured to generate a control signal based on the signals from the air sensor and the temperature sensor.
